(19) United States
(12) Patent Application Publication
(10) Pub. No.: US 2017/0243273 A1
(43) Pub. Date: Aug. 24, 2017

(54) SYSTEMS AND METHODS FOR PROCESSING PORTABLE OBJECT INFORMATION

(71) Applicant: CJZIP.com, Santa Barbara, CA (US)

(72) Inventor: Clelland John Ward, JR., Santa Barbara, CA (US)

(21) Appl. No.: 15/047,949

(22) Filed: Feb. 19, 2016

(51) Int. Cl. G06Q 30/06; H04L 29/08; G06Q 20/32

(52) U.S. Cl. CPC G06Q 30/0623; G06Q 20/322; H04L 67/12; H04L 67/146

(57) ABSTRACT

Provided herein are computing system, software media, networks, and methods for identify objects and delivering information of objects to targets based on beaconing technologies. The technologies enable object information to be portable.

### BACKGROUND

Information of interest has not been fully portable. In particular, unlike digital objects which are accessible everywhere, physical objects (e.g., vehicles, clothing, devices, instruments, foods) of a person's interest are not accessible immediately. Often, when people are close to a desired physical object, they are even not aware of the physical object. As such, new technologies are required to identify objects of interest and make information of the objects portable.

### SUMMARY

Provided herein are systems, software media, networks, and methods for automatically identifying interesting objects and processing portable object information based on beaconing technologies.

In one aspect, disclosed herein is a computing system for handling objects' information based on beaconing technologies, the system comprising: (a) a beacon device comprising an embedded processor, a memory module and a communication module, wherein the beacon device is attached to or placed in or upon an object and is configured to: (1) store a uniform resource locator (URL) associated with a server application, and (2) broadcast a beacon signal comprising brief information of the object; (b) a mobile device comprising a mobile processor, a memory module, and an operating system configured to execute machine readable instructions to create a mobile application for a mobile user, wherein the mobile application comprises: (1) a communication module configured to receive the beacon signal; and (2) an analysis module configured to (i) analyze the beacon signal to match the brief information of the object with a need of the mobile user, and (ii) when a match is found, the analysis module requests the communication module to send a trigger signal to the server application; and (c) a server comprising a server processor, a memory module, and an operating system configured to execute machine readable instructions to create the server application, wherein the server application comprises: a software module configured to (1) listen to the mobile application, and (2) upon receiving the trigger signal, acquire and present detailed information of the object from the URL to the mobile user on the mobile device. In some embodiments, the object comprises one or more of the following: an object for sale, a product, a vehicle, a piece of clothing. In some embodiments, the beacon device is further configured to store information of a manager of the system. In some embodiments, the beacon device is allowed to be configured remotely by a manager of the system. In some embodiments, the beacon device is allowed to be configured wirelessly by a manager of the system. In some embodiments, the beacon device is allowed to be configured a power level of the beacon signal. In some embodiments, the beacon device is allowed to be configured a power level of the beacon signal, wherein the power level is proportional to a range of the beacon signal. In some embodiments, the beacon device further comprises a sensor. In some embodiments, the beacon device further comprises a geolocation sensor and stores a location of the beacon device. In some embodiments, the beacon device further comprises a temperature sensor and stores a temperature. In some embodiments, the URL is in a shortened form of a complete URL of the server application. In some embodiments, the URL comprises 23 or less characters. In some embodiments, the brief information of the object comprises one or more of the following: a name of the object, an owner of the object, a price of the object, one or more features of the object, a color of the object, one or more features of targeted mobile users, a location of the object, and a physical address of the object. In some embodiments, the beacon signal is communicated based on one or more of the following: a Bluetooth protocol, a short range protocol, a WiFi protocol, any non-cellular protocol, and any cellular protocol. In some embodiments, the analysis module is further configured to, when the brief information of the object matches with the need of the mobile user, display a message on the mobile device to the mobile user. In some embodiments, the need of the mobile user comprises one or more of the following: one or more desired objects, one or more desired features of the object, a name of the object, an owner of the object, a price of the object, one or more features of the object, a color of the object, one or more features of targeted mobile users, a location of the object, a physical address of the object, an advertisement of the object, one or more images of the object, one or more video files of the object, a registration mechanism allowing the mobile user to use the server application, a login mechanism allowing the mobile user to use the server application, variations of the object, information of similar objects, a dealer of the object, a seller of the object, and a history of the object. In some embodiments, the server application further comprises a transaction module configured to, after the detailed information is presented to the mobile user, allow the mobile user to purchase the object.

In another aspect, disclosed herein is a non-transitory storage medium comprising a computer program including machine instructions executable by one or more processors to create two or more applications for handling objects' information based on beaconing technologies, the two or more applications comprising: (a) a mobile application comprises: (1) a communication module configured to receive a beacon signal from a beacon device, wherein the beacon device (i) is attached to or placed in or upon an object, (ii) stores a uniform resource locator (URL) associated with a server application, and (iii) broadcasts the beacon signal comprising brief information of the object; and (2) an analysis module configured to (i) analyze the beacon signal to match the brief information of the object with a need of the mobile user, and (ii) when a match is found, the analysis module requests the communication module to send a trigger signal to the server application; and (b) the server application comprising a software module configured to (1) listen to the mobile application, and (2) upon receiving the trigger signal, acquire and present detailed information of the object from the URL to the mobile user on the mobile device. In some embodiments, the object comprises one or more of the following: an object for sale, a product, a vehicle, and clothing. In some embodiments, the beacon device is further configured to store information of a manager of the system. In some embodiments, the beacon device is allowed to be configured remotely by a manager of the system. In some embodiments, the beacon device is allowed to be configured wirelessly by a manager of the system. In some embodiments, the beacon device is allowed to be configured a power level of the beacon signal. In some embodiments, the beacon device is allowed to be configured a power level of the beacon signal, wherein the power level is proportional to a range of the beacon signal. In some embodiments, the beacon device further comprises a sensor. In some embodiments, the beacon device further comprises a geolocation sensor and stores a location of the beacon device. In some embodiments, the beacon device further comprises a temperature sensor and stores a temperature. In some embodiments, the URL is in a shortened form of a complete URL of the server application. In some embodiments, the URL comprises 23 or less characters. In some embodiments, the brief information of the object comprises one or more of the following: a name of the object, an owner of the object, a price of the object, one or more features of the object, a color of the object, one or more features of targeted mobile users, a location of the object, and a physical address of the object. In some embodiments, the beacon signal is communicated based on a Bluetooth protocol, a short range protocol, a WiFi protocol, any cellular protocol, or a non-cellular protocol. In some embodiments, the analysis module is further configured to, when the brief information of the object matches with the need of the mobile user, display a message on the mobile device to the mobile user. In some embodiments, the need of the mobile user comprises one or more desired objects. In some embodiments, the need of the mobile user comprises one or more desired features of the object. In some embodiments, the detailed information of the object comprises one or more of the following: a name of the object, an owner of the object, a price of the object, one or more features of the object, a color of the object, one or more features of targeted mobile users, a location of the object, a physical address of the object, an advertisement of the object, one or more images of the object, one or more video files of the object, a registration mechanism allowing the mobile user to use the server application, a login mechanism allowing the mobile user to use the server application, variations of the object, information of similar objects, a dealer of the object, a seller of the object, and a history of the object. In some embodiments, the server application further comprises a transaction module configured to, after the detailed information is presented to the mobile user, allow the mobile user to purchase the object.

In another aspect, disclosed herein is a method for handling objects' information based on beaconing technologies, the method comprising: (a) storing in a beacon device a uniform resource locator (URL) associated with a server application, wherein the beacon device is attached to an object, (b) broadcasting, by the beacon device, a beacon signal comprising brief information of the object; (c) receiving, by a mobile device of a mobile user, the beacon signal; (d) analyzing, by the mobile device, the beacon signal to match the brief information of the object with a need of the mobile user, and, when a match is found, requesting a communication module of the mobile device to send a trigger signal to the server application; and (e) listening, by a server, to the mobile application, and, upon receiving the trigger signal, presenting detailed information of the object to the mobile user on the mobile device. In some embodiments, the object comprises one or more of the following: an object for sale, a product, a vehicle, and a piece of clothing. In some embodiments, the method further comprises storing, by the beacon device, information of a manager of the system. In some embodiments, the method further comprises configuring remotely the beacon device by a manager. In some embodiments, the method further comprises configuring wirelessly the beacon device by a manager. In some embodiments, the method further comprises configuring a power level of the beacon signal. In some embodiments, the method further comprises configuring a power level of the beacon signal, wherein the power level is proportional to a range of the beacon signal. In some embodiments, the beacon device further comprises a sensor. In some embodiments, the beacon device further comprises a geolocation sensor and the method stores a location of the beacon device. In some embodiments, the beacon device further comprises a temperature sensor and the method stores a temperature. In some embodiments, the URL is in a shortened form of a complete URL of the server application. In some embodiments, the URL comprises 23 or less characters. In some embodiments, the brief information of the object comprises one or more of the following: a name of the object, an owner of the object, a price of the object, one or more features of the object, a color of the object, one or more features of targeted mobile users, a location of the object, and a physical address of the object. In some embodiments, the beacon signal is communicated based on a Bluetooth protocol, a short range protocol, a WiFi protocol, any non-cellular protocol, or a cellular protocol In some embodiments, the method further comprises, when the brief information of the object matches with the need of the mobile user, displaying a message on the mobile device to the mobile user. In some embodiments, the need of the mobile user comprises one or more of the following: one or more desired objects, one or more desired features of the object, a name of the object, an owner of the object, a price of the object, one or more features of the object, a color of the object, one or more features of targeted mobile users, a location of the object, a physical address of the object, an advertisement of the object, one or more images of the object, one or more video files of the object, a registration mechanism allowing the mobile user to use the server application, a login mechanism allowing the mobile user to use the server application, variations of the object, information of similar objects, a dealer of the object, a seller of the object, and a history of the object. In some embodiments, the server application further comprises a transaction module configured to, after the detailed information is presented to the mobile user, allow the mobile user to purchase the object.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows an example processing flowchart of processing object information based on a beacon device.

FIG. 2 shows an example of a beacon device.

FIG. 3 shows an example structure of a beacon communication module of a mobile application.

FIG. 4 shows an example structure of an analysis module of a mobile application.

FIG. 5 shows an example structure of a server application.

FIG. 6 shows an example of configuring brief information for a beacon device and presenting the brief information to a mobile device.

FIG. 7 shows an example of presenting detailed information to a mobile device.

FIG. 8 shows an example of presenting detailed information of comparable objects to a mobile device.

FIG. 9 shows an example of presenting detailed information of comparable objects to a non-mobile device.

### DETAILED DESCRIPTION OF THE INVENTION

While various embodiments of the technologies have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In various embodiments, described herein includes a computing system for handling objects' information based on beaconing technologies. A system comprises: (a) a beacon device comprising an embedded processor, a memory module and a communication module, wherein the beacon device is attached to or placed in or upon an object and is configured to: (1) store a uniform resource locator (URL) associated with a server application, and (2) broadcast a beacon signal comprising brief information of the object; (b) a mobile device comprising a mobile processor, a memory module, and an operating system configured to execute machine readable instructions to create a mobile application for a mobile user, wherein the mobile application comprises: (1) a communication module configured to receive the beacon signal; and (2) an analysis module configured to (i) analyze the beacon signal to match the brief information of the object with a need of the mobile user, and (ii) when a match is found, the analysis module requests the communication module to send a trigger signal to the server application; and (c) a server comprising a server processor, a memory module, and an operating system configured to execute machine readable instructions to create the server application, wherein the server application comprises: a software module configured to (1) listen to the mobile application, and (2) upon receiving the trigger signal, acquire and present detailed information of the object from the URL to the mobile user on the mobile device.

In various embodiments, described herein includes a non-transitory storage medium comprising a computer program including machine instructions executable by one or more processors to create two or more applications for handling objects' information based on beaconing technologies, the two or more applications comprising: (a) a mobile application comprises: (1) a communication module configured to receive a beacon signal from a beacon device, wherein the beacon device (i) is attached to or placed in or upon an object, (ii) stores a uniform resource locator (URL) associated with a server application, and (iii) broadcasts the beacon signal comprising brief information of the object; and (2) an analysis module configured to (i) analyze the beacon signal to match the brief information of the object with a need of the mobile user, and (ii) when a match is found, the analysis module requests the communication module to send a trigger signal to the server application; and (b) the server application comprising a software module configured to (1) listen to the mobile application, and (2) upon receiving the trigger signal, acquire and present detailed information of the object from the URL to the mobile user on the mobile device.

In various embodiments, described herein includes a method for handling objects' information based on beaconing technologies, the method comprising: (a) storing in a beacon device a uniform resource locator (URL) associated with a server application, wherein the beacon device is attached to, placed in or upon an object, (b) broadcasting, by the beacon device, a beacon signal comprising brief information of the object; (c) receiving, by a mobile device of a mobile user, the beacon signal; (d) analyzing, by the mobile device, the beacon signal to match the brief information of the object with a need of the mobile user, and, when a match is found, requesting a communication module of the mobile device to send a trigger signal to the server application; and (e) listening, by a server, to the mobile application, and, upon receiving the trigger signal, presenting detailed information of the object to the mobile user on the mobile device. In some embodiments, the object comprises one or more of the following: an object for sale, a product, a vehicle, and a piece of clothing.

### Object

In various embodiments, the systems, platforms, software media, networks, and methods described herein include an object, use of the same. In some embodiments, an object is a physical object, such as a vehicle, a device, an instrument, a machine, a chemical, a food, a produce, a furniture, a book, a publication, a stationary, an accessory, a piece of clothing, a building, and a real estate. A person with skills in the art can readily recognize any object to be applied herein.

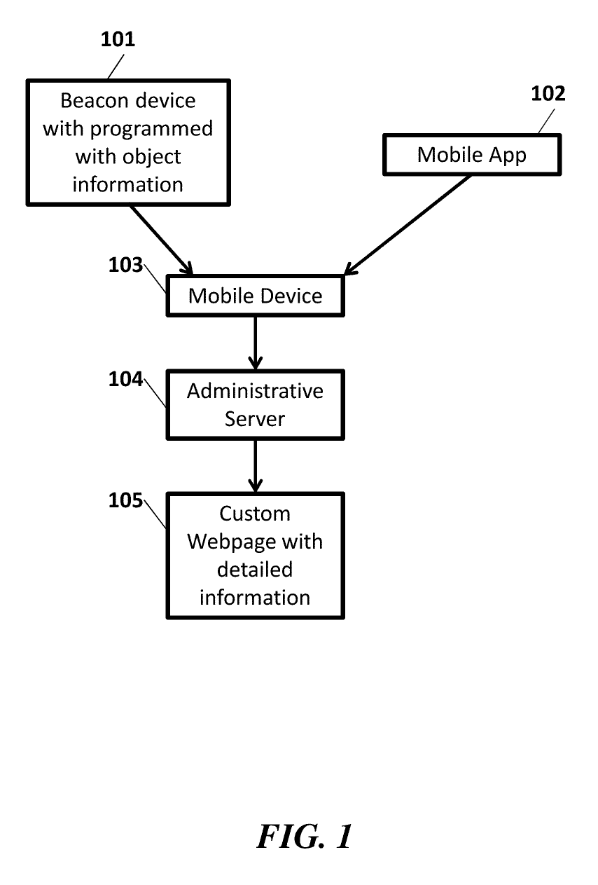

The technologies described herein are able to make information of an object portable. FIG. 1 shows an example flowchart of data processing. Referring to FIG. 1, a beacon device 101 is programmed with information of an object. The beacon device is configured to broadcast a beacon signal to a mobile device 103, which has a mobile application 102 installed. The mobile device receives the beacon signal, and triggers the mobile application to analyze the information content of the beacon signal. When the mobile application identifies a match between a need of a mobile user and the beacon's information content, the mobile application communicates with a server 104 to present a webpage 105 with detailed information of the object.

### Beacon Device

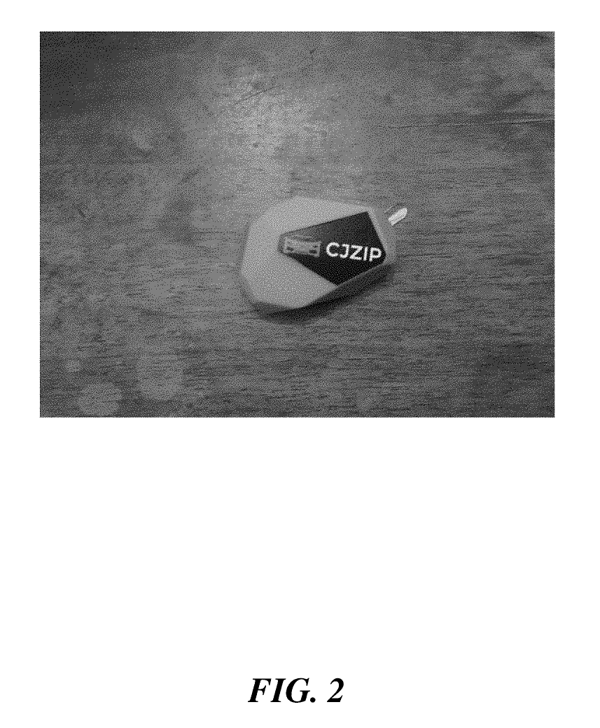

In various embodiments, the systems, platforms, software media, networks, and methods described herein include a beacon device, use of the same. FIG. 2 shows a sample beacon device. In some embodiments, a beacon device comprises a processor and a memory module. In some embodiments, a beacon device comprises one or more sensors. In some embodiments, a sensor is able to detect or transmit a signal, in a form of electrical, magnetic, optical, mechanical, thermal, chemical, biological, or physiological. Examples of sensors include, but not limited, RF tags, light sensors, electromagnetic wave sensors, wind sensors, rain sensors, snow sensors, soil sensors, water sensors, liquid sensors, gas sensors, carbon dioxide sensors, carbon monoxide sensors, oxygen sensors, chemical sensors, toxicity sensors, acid sensors, alkaline sensors, speed sensors, temperature sensors, pressure sensors, load sensors, weight sensors, torque sensors, force sensors, electric current sensors, and voltage sensors. In some designs, two or more same type or different types of sensors are used.

In some embodiments, a beacon device comprising a sensor is configured to broadcast one or more radio signals, or called beacon signals herein. Further, the radio signals are directly received by a computing device, such as a smartphone, a table, a laptop, a communication gateway. In some applications, the radio signals are indirectly received by a computing device (e.g., a server, and a desktop computer) via one or more relaying devices. In further embodiments, when a computing device receives the radio signals, it processes and interprets the signals to achieve various tasks, such as identifying a location, inferring contextual awareness, understand proximity to a nearby location or object, recognizing object types, recognizing ownership, approximating a location, detecting a temperature, and tracking a motion.

In some embodiments, a beacon device comprises a communication module. In some embodiments, a communication module comprises a sensor. In some embodiments, a sensor comprises a functionality of communication. In some embodiments, communication functionality of a sensor or a communication module is two way or one way. One way communication comprises broadcasting/transmitting signals only, or receiving signals only.

In some embodiments, a beacon device is programmable. In certain cases, a beacon device is configured to store information of a manager of the system. Further, a beacon device is allowed to be configured remotely by a manager of the system. In some situations, a beacon device is allowed to be configured wirelessly by a manager of the system.

In some embodiments, a beacon device is allowed to be configured a power level of a beacon signal. In some embodiments, a beacon device is allowed to be configured a power level of a beacon signal, wherein the power level is proportional to a range of the beacon signal.

In some embodiments, a beacon device comprises a geolocation sensor and stores a location of the beacon device. In some embodiments, a beacon device does not comprise a geolocation sensor, and it is programmed with a location to be placed.

In some embodiments, a beacon device comprises a temperature sensor and stores a temperature. In some embodiments, the beacon device does not comprise a temperature sensor, and it is programmed to store a temperature.

In some embodiments, a beacon device is programmed to store a uniform resource locator (URL). A URL can be a URL of a server application. In further embodiments, a URL is in a shortened form of a complete URL. In some designs, a URL comprises 23 or less characters. Alternative designs configure a URL to be less than 100, 90, 80, 70, 60, 50, 40, 30, 20, 10, or 5 characters.

In some embodiments, a beacon device is programmed to store brief information of an object. In additional embodiments, the beacon device is configured to broadcast/transmit a beacon signal comprising the brief information. In some cases, a beacon signal comprises a URL. Examples of brief information include, but not limited to, a name of the object, an owner of the object, a price of the object, one or more features of the object, a color of the object, one or more features of targeted mobile users, a location of the object, and a physical address of the object.

In some embodiments, a beacon signal is communicated based on one or more of the following: a Bluetooth protocol, a short range protocol, a WiFi protocol, any non-cellular protocol, and any cellular protocol. Examples of non-cellular communication technologies and/or protocols include, but not limited to, IEEE 802.11 standards, IEEE 802.16 standards, AP/STA protocols, Independent Basic Service Set (IBSS), Peer-to-Peer (P2P), P2P-GO/P2P-Client, Long Term Evolution Direct (LTE Direct), Worldwide Interoperability for Microwave Access (WiMAX), IEEE 802.16, Bluetooth, Mobile Multi-Hop Relay (MMR) Bluetooth, and FlashLinQ. Examples of cellular communication technologies and/or protocols include, but not limited to, Global System for Mobile Communications (GSM), General Packet Radio Service (GPRS), Enhanced Data Rates for GSM Evolution (EDGE), Universal Mobile Telecommunications System (UMTS), Code Division Multiple Access (CDMA), Wideband Code Division Multiple Access (W-CDMA), High Speed Packet Access (HSPA), Long Term Evolution (LTE), Long Term Evolution Advanced (LTE Advance), Long Term Evolution Direct (LTE Direct), and Worldwide Interoperability for Microwave Access (WiMAX).

In some embodiments, the appearance of a beacon device has various possible designs. In some designs, a beacon device is made like a sticker. In some implementations, a beacon device is made like a business card. In some designs, a beacon device is made like a ball. In some cases, a beacon device is made like a clip. In certain cases, a beacon device is made like a pen. In some applications, a beacon device is made like a toy. A person with skills in the art can readily recognize any shape design of a beacon device. Further, the internal functional modules are not limited by an appearance design of a beacon device.

### Mobile Application

In various embodiments, the systems, platforms, software media, networks, and methods described herein include a mobile application, or use of the same.

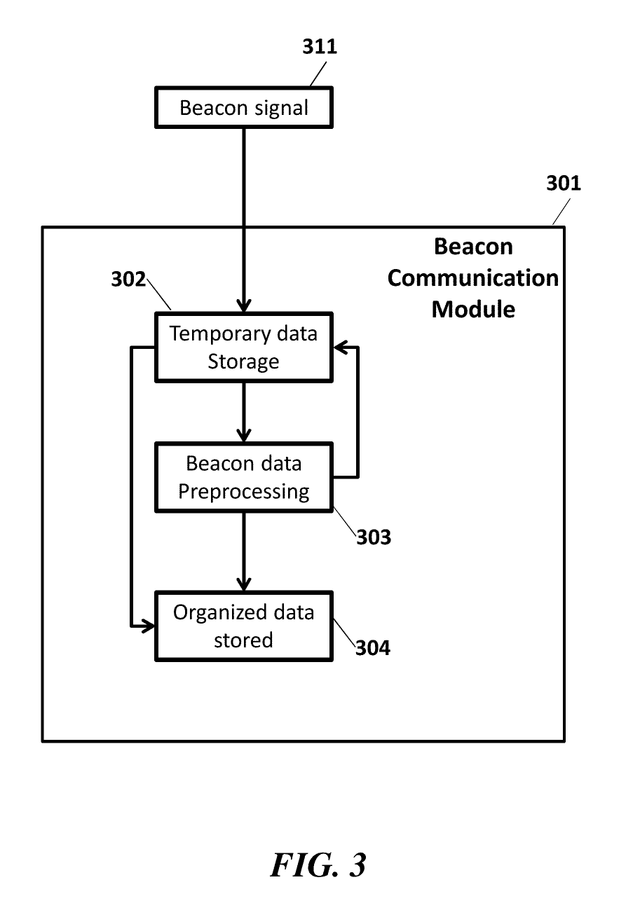

In some embodiments, a mobile application comprises a beacon communication/receiving module configured to preprocess a beacon signal. FIG. 3 illustrates an example of a beacon communication/receiving module. In certain implementations, a beacon communication module 301 comprises a converter to convert a physical beacon signal 311 into data stored in temporary data storage 302, such as a memory device or a permanent storage, to store the beacon signals. In some designs, a beacon communication/receiving module further comprises a beacon data preprocessing 303 to extract brief information of an object. A preprocessing 303 organizes temporarily stored data into a predefined format and stores the reorganized data into an internal data structure 304.

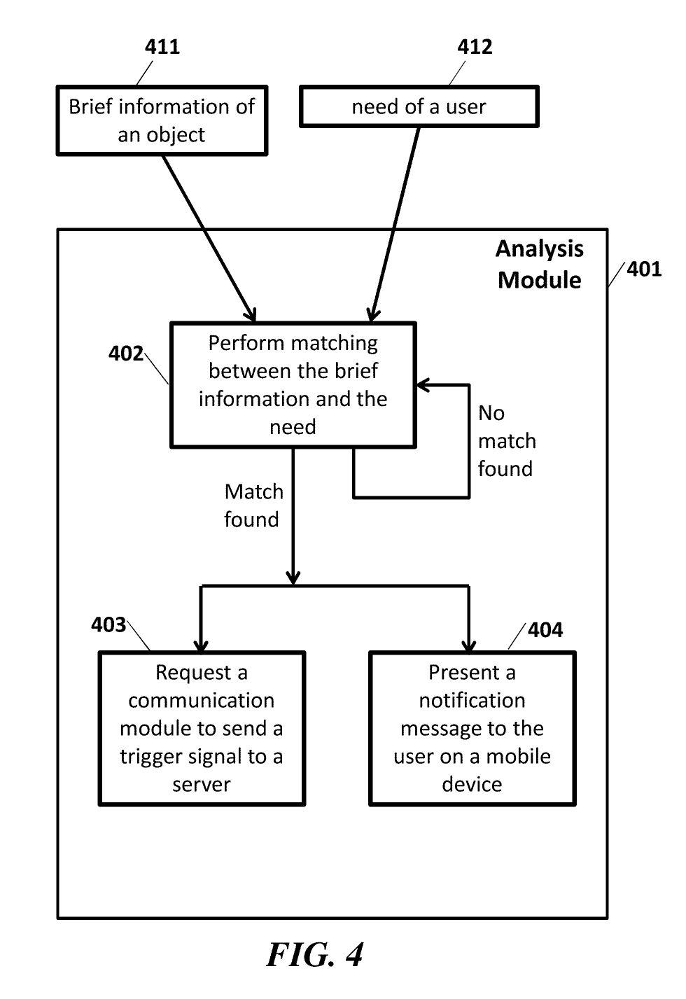

In some embodiments, a mobile application comprises an analysis module configured to analyze a beacon signal. In certain designs, an analysis module analyzes brief information contained in a beacon signal. FIG. 4 illustrates an example of an analysis module. Input of an analysis module 401 comprises organized data of brief information of an object 411, and a need of a user 412. Examples of a need of the mobile user comprises one or more of the following: one or more desired objects, one or more desired features, a name, an owner, a price, one or more features, a color, a location, a neighborhood, and an address.

Referring to FIG. 4, an analysis module 401 performs a matching algorithm 402 to identify one or more matches between the brief information 411 and the need 412. When a match is found, the analysis module executes a further step 403, or 404, or both. In step 403, the analysis module requests a communication module of the mobile device to send a trigger signal to a server. In step 404, the analysis module presents a notification message to the user on a mobile device.

Examples of matching algorithms include, but not limited to, approximate string matching, string searching algorithm, Aho-Corasick algorithm, Apostolico-Giancarlo algorithm, Bitap algorithm, Boyer-Moore string search algorithm, Boyer-Moore-Horspool algorithm, Commentz-Walter algorithm, Knuth-Morris-Pratt algorithm, Levenshtein automaton, Rabin-Karp algorithm, Raita Algorithm, and Zhu-Takaoka string matching algorithm.

In some embodiments, a match algorithm performs matching based on keywords. In some embodiments, a matching is based on an exact keyword match; i.e., a keyword must be exactly present in brief information and in a need of a user. In some embodiments, a matching is based on a match with similar meanings; i.e., meaning in brief information is similar to meaning in a need of user regardless of the exact words in the descriptions of the brief information and the need.

In some embodiments, a matching algorithm is based on a linguistic processing. In some embodiments, a matching is based on a probabilistic and statistical analysis on the brief information and the user need to infer a match. In some embodiments, a matching is based on a scoring mechanism. Matching is based on giving a match score; when a score is beyond a threshold, the match is declared.

In some embodiments, a matching process comprises using two or more algorithms. For example, two or more algorithms are used to generate matching results, followed by a consensus analysis on the results. Alternatively, a first algorithm is used to generate a first matching result, and a second algorithm is used to generate a second matching result conditioned on given the first matching results.

In some embodiments, a computer program comprising a mobile application is provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Server Application

In various embodiments, the systems, platforms, software media, networks, and methods described herein include a server, or use of the same. A server comprises a computer program being executed to create a server application.

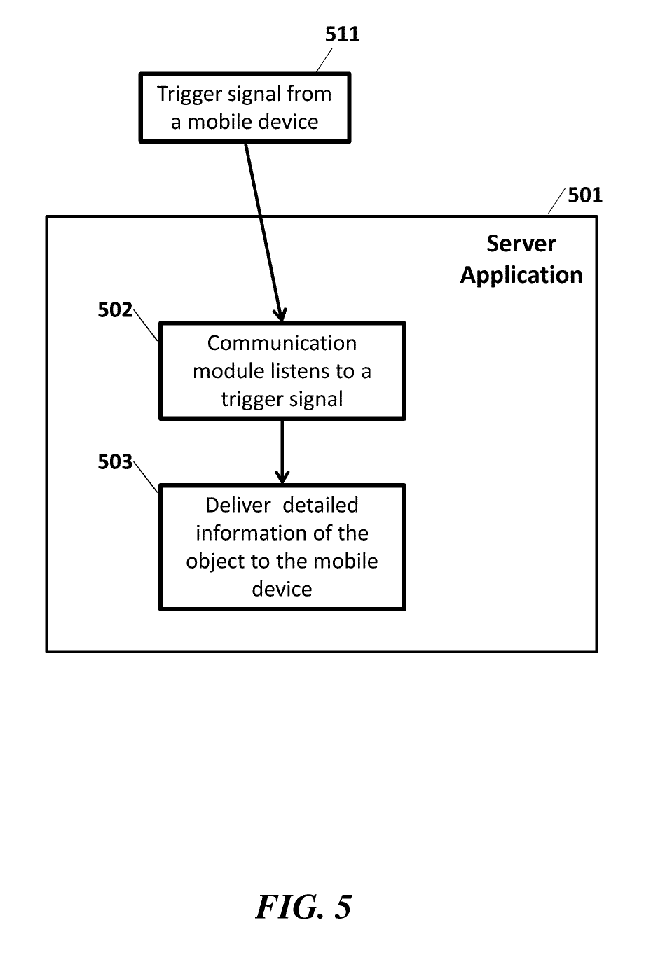

FIG. 5 illustrates an example server application 501. In some embodiments, a server application 501 comprises a communication module 502 configured to listen to a trigger signal 511 from a mobile device. Once a trigger signal comes, in step 503 the server application is triggered to deliver detailed information of the object to the mobile device.

In some embodiments, detailed information comprises one or more of the following: one or more desired objects, one or more desired features of the object, a name of the object, an owner of the object, a price of the object, one or more features of the object, a color of the object, one or more features of targeted mobile users, a location of the object, a physical address of the object, an advertisement of the object, one or more images of the object, one or more video files of the object,

In some implementations, detailed information further comprises one or more of the following: a registration mechanism allowing the mobile user to use the server application, a login mechanism allowing the mobile user to use the server application, variations of the object, information of similar objects, a dealer of the object, a seller of the object, and a history of the object.

In some embodiments, a server application further comprises a transaction module configured to, after the detailed information is presented to the mobile user, allow the mobile user to purchase the object.

In some embodiments, a server application comprises a physical web application. In some embodiments, a physical web application presents brief information or detailed information or both to a user's computing device, such as a mobile device and desktop device.

In some embodiments, a server application comprises a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Digital Processing Device

In various embodiments, the systems, platforms, software, networks, and methods described herein include a digital processing device, or use of the same. In further embodiments, the digital processing device includes one or more hardware central processing units (CPUs), i.e., processors that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, a digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server® , Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, a digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, a digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, a digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, a digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280× about 720 pixels or at least about 1920× about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

### Non-transitory Computer Readable Storage Medium

In various embodiments, the systems, platforms, software, networks, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In various embodiments, the systems, platforms, software, networks, and methods disclosed herein include at least one computer program. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, platforms, software, networks, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

### Example 1

### Portable Vehicle Information

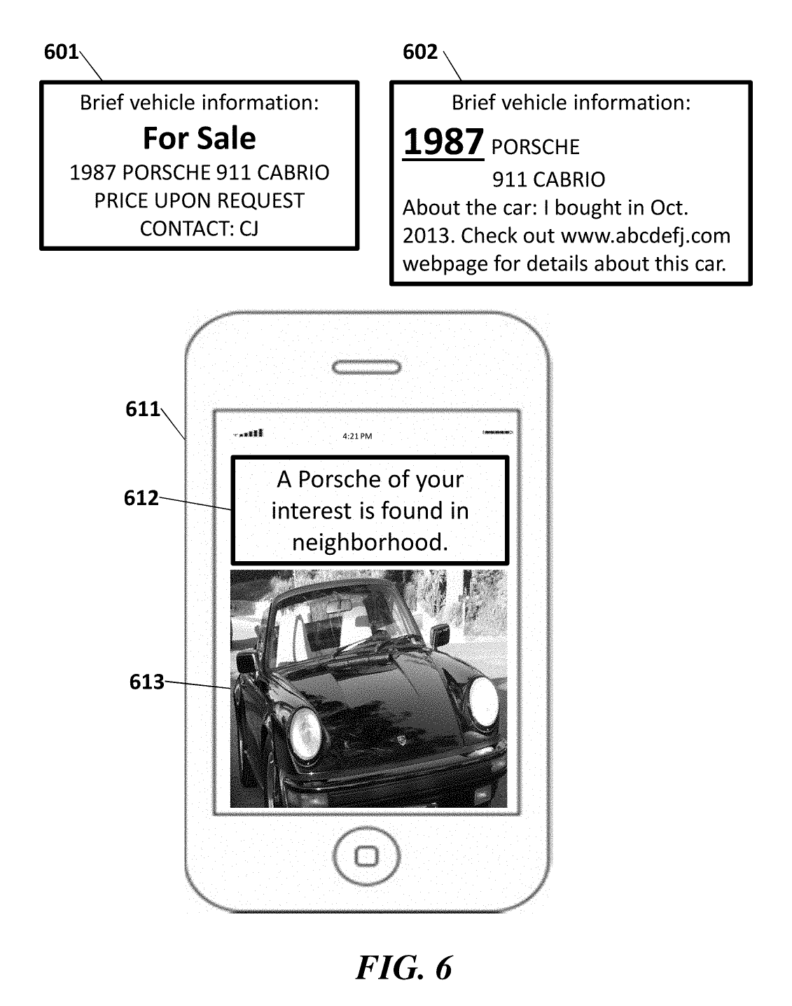

FIG. 6 shows an example of processing portable vehicle information. A beacon device is programmed with brief information. Two examples of brief information are shown in 601 and 602, respectively. The 601 brief information comprises: “For Sale. 1987 PORSCHE 911 CABRIO. PRICE UPON REQUEST. CONTACT: CJ”. The 602 brief information comprises: “1987 PORSCHE. 911 CABRIO. About the car: I bought in October 2013. Check out www.abcdefj.com webpage for details about this car.”

The brief information is broadcasted to a near range of the beacon device. When a mobile device 611 receives the brief information, the mobile device analyzes the brief information and performs a match between the brief information and a need of the user of the mobile device. When a match is found, the mobile device presents a notification text message 612 “A Porsche of your interest is found in the neighborhood. In some case, a picture 613 linked to the brief information is downloaded and presented along with the message 612. In some cases, a notification comprises one or more sound alerts. In some design, a notification comprises a voice or a sound or a video clip briefly describing the information of the car.

The mobile device further detects the mobile user's reactions to the notification. Detection is based on one or more of the following: an action acted on the notification (e.g., reading, wiping, sliding, flicking, clicking, typing), and a time length of accessing (e.g., reading, watching, listening) the contents of the notification.

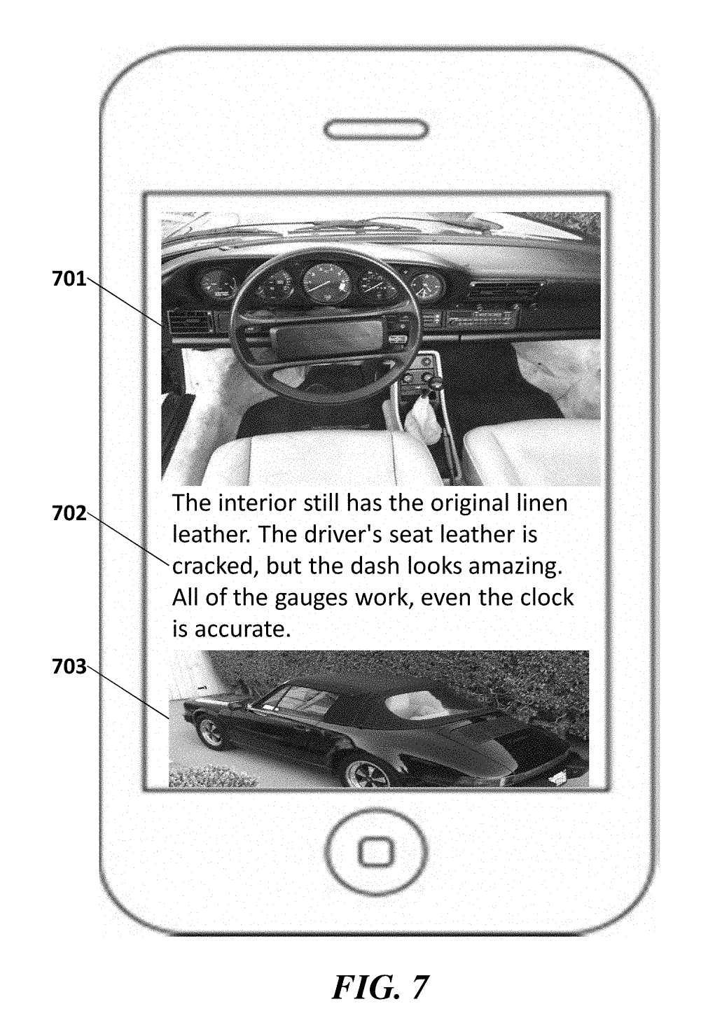

Based on the detection results, the mobile device determines if the mobile user has further interest in acquiring more detailed information of the car. If the mobile user has an interest, the mobile device communicates with a server to allow a server application to retrieve detailed information and deliver the detailed information to the mobile device. In this example, FIG. 7 shows detailed information comprising an interior view of the car 701, a more detailed description of the car 702, and another view of the car 703.

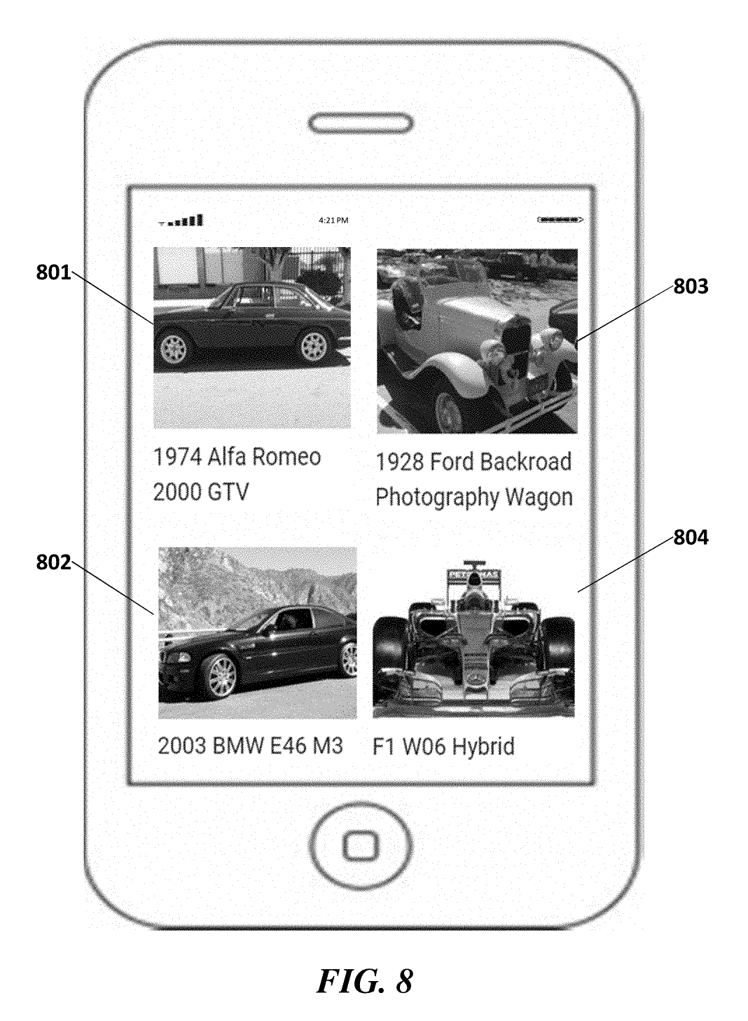

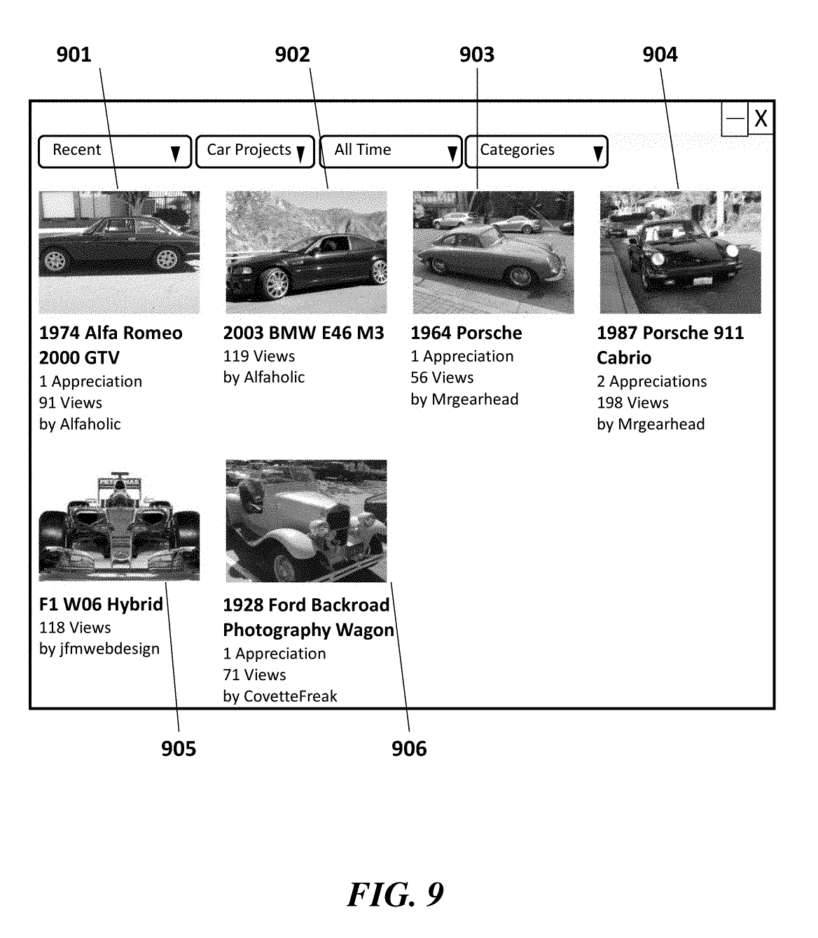

Moreover, after viewing all the detailed information, the mobile application on the mobile device further automatically presents a set of similar cars matching the user's need, shown in FIG. 8. The mobile device shows four comparable cars: 1974 Alfa Romeo (801), 2003 BMW E46 M3 (802), 1928 Ford Backroad Photography Wagan (803), and F1 W06 Hybrid (804). In an additional design or an alternative design, when the mobile user accesses another computing device (e.g., a tablet, a desktop computer, a laptop, a second mobile device) and opens an Internet browser, the server application automatically delivers a page to the user to show detailed information of the cars, shown in FIG. 9. In this example, six cars are presented: 1974 Alfa Romeo (901), 2003 BMW E46 M3 (902), 1964 Porsche (903), 1987 Porsche 911 Cabrio (904), F1 W06 Hybrid (905), and 1928 Ford Backroad Photography Wagan (906).

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the disclosure. It is intended that the following claims define the scope of the invention and that methods and structures within the scope of these claims and their equivalents be covered thereby.

1. A computing system for porting information of physical objects based on beaconing technologies, the system comprising:
(a) a beacon device comprising a processor, a memory and a sensor, wherein the beacon device is attached to, or placed in or upon a vehicle and is configured to:
(1) store a uniform resource locator (URL) associated with a server application,
(2) broadcast a beacon signal comprising brief information of the vehicle, and
(3) allow a power level of the beacon signal to be configured remotely and wirelessly by a manager of the system;
(b) a mobile device comprising a mobile processor, a memory, and an operating system configured to execute machine readable instructions to create a mobile application for a mobile user, wherein the mobile application:
(1) communicates with the beacon device to receive the beacon signal; and
(2) analyzes the beacon signal to (i) match the brief information of the vehicle with a need of the mobile user, and (ii) when a match is found, send a trigger signal to the server application; and
(c) a server comprising a server processor, a memory, and an operating system configured to execute machine readable instructions to create the server application, wherein the server application (1) listens to the mobile application, and (2) upon receiving the trigger signal, acquires detailed information of the vehicle from the URL and presents the detailed information to the mobile user on the mobile device.

2. (canceled)

3. The system of claim 1, wherein the beacon device is further configured to store information of a manager of the system.

4. (canceled)

5. (canceled)

6. (canceled)

7. The system of claim 1, wherein the URL is in a shortened form of a complete URL of the server application.

8. The system of claim 1, wherein the brief information of the vehicle comprises one or more of the following: a name of the vehicle, an owner of the vehicle, a price of the vehicle, one or more features of the vehicle, a color of the vehicle, a location of the vehicle, and a physical address of the vehicle.

9. (canceled)

10. The system of claim 1, wherein the beacon signal is broadcasted or communicated based on a Bluetooth protocol.

11. The system of claim 1, wherein the mobile application further, when the brief information of the vehicle matches with the need of the mobile user, displays a message on the mobile device to the mobile user.

12. The system of claim 1, wherein the need of the mobile user comprises one or more desired vehicles, and one or more features of the desired vehicles.

13. The system of claim 1, wherein the detailed information of the vehicle comprises one or more of the following: a name of the vehicle, an owner of the vehicle, a price of the vehicle, one or more features of the vehicle, a color of the vehicle, a location of the vehicle, a physical address of the vehicle, one or more images of the vehicle, one or more video files of the vehicle, and a dealer of the vehicle.

14. The system of claim 1, wherein the detailed information of the vehicle comprises an advertisement of the vehicle.

15. The system of claim 1, wherein the detailed information of the vehicle comprises a registration mechanism and a login mechanism allowing the mobile user to use the server application.

16. The system of claim 1, wherein the detailed information of the vehicle comprises variations of the vehicle.

17. The system of claim 1, wherein the detailed information of the vehicle comprises information of similar vehicle.

18. The system of claim 1, wherein the detailed information of the vehicle comprises a seller of the vehicle.

19. The system of claim 1, wherein the detailed information of the vehicle comprises a history of the vehicle.

20. The system of claim 1, wherein the server application further, after the detailed information is presented to the mobile user, allows the mobile user to purchase the vehicle.
